(19) United States
(12) Patent Application Publication
(10) Pub. No.: US 2026/0253785 A1
(43) Pub. Date: Aug. 27, 2026

(54) SYSTEMS, METHODS, AND STRUCTURES FOR PROVIDING AN IMPROVED TRANSFORMER FERRITE CORE FOR ISOLATED CIRCUITS

(71) Applicant: Allegro MicroSystems, LLC, Manchester, NH (US)

(72) Inventors: Zoran Pavlovic, Antibes (FR); Andrew Thompson, Cheshire (GB)

(73) Assignee: Allegro MicroSystems, LLC, Manchester, NH (US)

(21) Appl. No.: 19/061,094

(22) Filed: Feb. 24, 2025

(51) Int. Cl. H01F 27/28; H01F 27/24; H01F 41/02; H01F 41/04

(52) U.S. Cl. CPC H01F 27/28; H01F 27/24; H01F 41/0206; H01F 41/04

(57) ABSTRACT

Disclosed are example systems, methods, and structures for providing an improved transformer. Also disclosed are example systems, methods, and structures for providing an improved system including a transformer. Further disclosed are example systems, methods, and structures for providing an improved magnetic core for a transformer. For example, disclosed are example systems, methods, and structures for providing an improved ferrite core for transformers used in galvanically isolated circuits, such as galvanically isolated gate drivers. Example systems, methods, and structures described herein provide for constructing transformer cores out of multiple components composed of different materials. By using multiple different materials to construct a transformer core, the size (i.e., dimensions) of a transformer may be minimized. Moreover, constructing a transformer core of multiple materials may minimize performance changes of a transformer across temperature variations.

### BACKGROUND

In the field of power electronics, switch drive circuits are often employed to turn switches on and off.

Switches are commonly used in a wide variety of electronic systems. Solid state switches typically include a transistor structure. Switches usually control the flow of current from a power source to a load. The controlling electrode of the switch, usually referred to as its gate (or base), is typically controlled (driven) by a switch drive circuit, sometimes also referred to as a gate drive circuit. Such solid state switches are typically voltage-controlled, turning on when the gate voltage exceeds a manufacturer-specific threshold voltage by a margin, and turning off when the gate voltage remains below the threshold voltage by a margin.

Switch drive circuits typically receive their control instructions from a controller, such as a pulse-width-modulated (PWM) controller, via one or more switch driver inputs. Switch drive circuits deliver their drive signals directly (or indirectly via networks of active and/or passive components) to one or more terminals (e.g., gate, source, drain) of the switch.

Some electronic systems, including ones with solid state switches, have employed galvanic isolation to prevent undesirable direct current (DC) currents from flowing from one side of an isolation barrier to the other. Such galvanic isolation can be used to separate circuits in order to protect users from coming into direct contact with hazardous voltages. Galvanic isolation may also be used to intentionally separate electrical circuits with hazardous or safe voltages on both sides of the isolation barrier, in order to simplify circuit design, reduce cost, and/or improve system performance.

It is a common situation that the control circuit and the switch driver inputs reside on one side of the galvanic isolation barrier, while the switch driven by the switch driver resides on the other side of the isolation barrier. In other words, the switch drive circuit crosses the isolation barrier, and hence may become a safety-critical component.

Various transmission techniques are available for signals to be sent across galvanic isolation barriers, including optical, capacitive, and magnetic coupling techniques. Magnetic coupling typically relies on use of a transformer to magnetically couple circuits on the different sides of the transformer, typically referred to as the primary and secondary sides, while also providing galvanic separation of the circuits.

Transformers used for magnetic-coupling isolation barriers typically utilize a magnetic core to provide a magnetic path to channel flux created by the currents flowing in the primary and secondary sides of the transformer. However, use of magnetic-coupling isolation barriers may have drawbacks, such as manufacturing problems, for integrated circuit (IC) packages due to the included magnetic core.

### SUMMARY

Disclosed are example systems, methods, and structures for providing an improved transformer. Also disclosed are example systems, methods, and structures for providing an improved system including a transformer. Further disclosed are example systems, methods, and structures for providing an improved magnetic core for a transformer. For example, disclosed are example systems, methods, and structures for providing an improved ferrite core for transformers used in galvanically isolated circuits, such as galvanically isolated gate drivers. Example systems, methods, and structures described herein provide for constructing transformer cores out of multiple components composed of different materials. By using multiple different materials to construct a transformer core, the size (i.e., dimensions) of a transformer may be minimized. Moreover, constructing a transformer core of multiple materials may minimize performance changes of a transformer across temperature variations.

In accordance with some embodiments, there is provided a system comprising a magnetic isolation transformer. The magnetic isolation transformer comprises a multi-component magnetic core having a first component with a first soft ferromagnetic material having a first permeability and a second component with a second soft ferromagnetic material having a second permeability. The magnetic isolation transformer also comprises a primary coil configured about the multi-component magnetic core, and a secondary coil configured about the multi-component magnetic core. The multi-component magnetic core is configured to provide reduced variation in inductance across a given temperature range than if the first and second components included the same soft ferromagnetic material.

In some embodiments, the system further comprises control circuitry configured to supply control pulses to the primary coil.

In further embodiments, the system further comprises a gate driver integrated circuit (IC) connected to the secondary coil.

In still further embodiments, the first component is in a first region and the second component is in a second region. The magnetic isolation transformer includes a controlled gradient of magnetic permeability from the first region to the second region, the controlled gradient increasing away from a center of the multi-component magnetic core.

In some embodiments, the controlled gradient of magnetic permeability is linear.

In further embodiments, the controlled gradient of magnetic permeability is exponential.

In still further embodiments, the system further comprises a third core component having a third soft ferromagnetic material with a third magnetic permeability.

In some embodiments, the first component and/or the second component comprises ferrite.

In further embodiments, the second permeability is greater than the first permeability.

Furthermore, in accordance with some embodiments, there is provided a method of making a system comprising a magnetic isolation transformer with a multi-component magnetic core. The method comprises providing a multi-component magnetic core having a first component with a first soft ferromagnetic material having a first permeability and a second component with a second soft ferromagnetic material having a second permeability. The method also comprises providing a primary coil configured about the multi-component magnetic core, and providing a secondary coil configured about the multi-component magnetic core. The multi-component magnetic core is configured to provide reduced variation in inductance across a given temperature range than if the first and second components included the same soft ferromagnetic material.

In some embodiments, the method further comprises providing control circuitry configured to supply control pulses to the primary coil.

In further embodiments, the method further comprises connecting a gate driver integrated circuit (IC) to the secondary coil.

In still further embodiments, the first component is in a first region and the second component is in a second region. The magnetic isolation transformer includes a controlled gradient of magnetic permeability from the first region to the second region, the controlled gradient increasing away from a center of the multi-component magnetic core.

In some embodiments, the controlled gradient of magnetic permeability is linear.

In further embodiments, the controlled gradient of magnetic permeability is exponential.

In still further embodiments, the method further comprises providing a third core component having a third soft ferromagnetic material with a third magnetic permeability.

In some embodiments, the method further comprises using a three-dimensional (3D) printer to form at least one component of the multi-component magnetic core.

In further embodiments, the method further comprises joining the first and second components.

In still further embodiments, joining the first and second components includes bonding.

In some embodiments, joining the first and second components includes press fitting.

In further embodiments, joining the first and second components includes heating or cooling one or more of the first or second components.

In still further embodiments, the first component and/or the second component comprises ferrite.

In some embodiments, the second permeability is greater than the first permeability.

Additionally, in accordance with some embodiments, there is provided a magnetic isolation transformer. The magnetic isolation transformer comprises a multi-component magnetic core having a first component with a first soft ferromagnetic material having a first permeability and a second component with a second soft ferromagnetic material having a second permeability. The magnetic isolation transformer further comprises a primary coil configured about the multi-component magnetic core, and a secondary coil configured about the multi-component magnetic core. The multi-component magnetic core is configured to provide reduced variation in inductance across a given temperature range than if the first and second components included the same soft ferromagnetic material.

Before explaining example embodiments consistent with the present disclosure in detail, it is to be understood that the disclosure is not limited in its application to the details of constructions and to the arrangements set forth in the following description or illustrated in the drawings. The disclosure is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings are incorporated in and constitute part of this specification. The drawings, together with the description, illustrate and serve to explain the principles of various example embodiments of the disclosure.

FIG. 1 is a diagram of example multi-component transformer cores, consistent with embodiments of the present disclosure.

FIG. 2 is a diagram of an example multi-channel system including a substrate, multi-component transformer, and primary and secondary side integrated circuits (ICs), consistent with embodiments of the present disclosure.

FIG. 3 is a diagram of another example multi-channel system including a substrate, multi-component transformer, and primary and secondary side integrated circuits (ICs), consistent with embodiments of the present disclosure.

FIG. 4 is a diagram of an example multi-component transformer core, consistent with embodiments of the present disclosure.

FIG. 5A is a diagram of a first view of an example configuration of a multi-component transformer core, consistent with embodiments of the present disclosure.

FIG. 5B is a diagram of a second view of an example configuration of a multi-component transformer core, consistent with embodiments of the present disclosure.

FIG. 6 is a flow chart of an example process for making a magnetic isolation transformer with a multi-component magnetic core, consistent with embodiments of the present disclosure.

FIG. 7 is a flow chart of an example process for making a system comprising a magnetic isolation transformer with a multi-component magnetic core, consistent with embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Reference will now be made in detail to the embodiments of the disclosure, certain examples of which are illustrated in the accompanying drawings.

In the following description, numerous specific details are set forth regarding the systems, methods, and structures of the disclosed subject matter, and the environment in which such systems, methods, and structures operate, to provide a thorough understanding of the disclosed subject matter. After reading the descriptions provided herein, it will be apparent to one skilled in the art, however, that the disclosed subject matter may be practiced without such specific details. It will also be apparent to one skilled in the art that certain features, which are well known within the art, are not described in detail to avoid unnecessary complication of the description of the systems, methods, and structures described herein. In addition, it will be understood that the embodiments provided below are examples, and that it is contemplated that there are other systems, methods, and structures that are within the scope of the subject matter disclosed herein.

Aspects, examples, and embodiments of the present disclosure are directed to and include systems, methods, transformer structures, transformer assemblies, and/or packages. Such systems, methods, transformer structures, transformer assemblies, and/or packages may be used to provide galvanic isolation (e.g., electrical isolation), such as voltage and/or current isolation, in high-voltage applications, for example. In some embodiments, a transformer may have a step up, step down, or power transformer configuration. In some embodiments, a transformer may have one or more input and/or output coils/coil structures that provide galvanic isolation for one or more channels (e.g., control signal and/or power channels).

The systems, methods, transformer structures, transformer assemblies, and/or packages (e.g., modules) disclosed herein may comprise various types of circuits (e.g., integrated circuits (ICs)). In some examples provided herein, transformer packages with ICs may include a galvanically isolated gate driver or other high voltage circuit. One or more (e.g., first and second) semiconductor die having one or more integrated circuits (e.g., an “IC die”) may be included in the packages. Such ICs may include, for example, high-voltage circuits such as galvanically-isolated gate drivers configured to drive an external gate on a solid-state switch, though the disclosure is not so limited. Such a solid-state switch may include, for example, a field effect transistor (FET), a metal oxide semiconductor FET (MOSFET), a metal semiconductor FET (MESFET), a gallium nitride FET (GaN FET), a high electron mobility transistor (HEMT), a silicon carbide FET (SiC FET), an insulated gate bipolar transistor (IGBT), or another type of load.

Use of a transformer in a circuit may impose constraints on the circuit. For example, a transformer may be a large component, and may require a lot of space on a substrate (e.g., printed circuit board, integrated circuit (IC)) on which a circuit is implemented. The size of these components may make it challenging to use transformers in smaller packages, such as in small, pre-packaged ICs. Transformers may also have characteristics that vary depending on the environment in which they are implemented. For example, a permeability, saturation, and/or inductance of a transformer may vary as temperature in an environment varies. These variations in the properties of a transformer may be problematic in circuits that are used in certain environments, such as in outdoor applications such as electric vehicle (EV) chargers or industrial applications in harsh environments where temperatures may vary widely.

Systems, methods, and structures disclosed herein may address these potential problems. For example, systems, methods, and structures disclosed herein may be utilized to provide an improved transformer. Systems, methods, and structures disclosed herein may also be utilized to provide an improved system including a transformer. Systems, methods, and structures disclosed herein may also be utilized to provide an improved magnetic core for a transformer. For example, disclosed are example systems, methods, and structures for providing an improved ferrite core for transformers, such as transformers used in galvanically isolated circuits (e.g., galvanically isolated gate driver circuits). Example systems, methods, and structures disclosed herein provide for constructing transformer cores out of multiple components. The components may be constructed of different materials. By selecting multiple materials having different characteristics to construct a transformer core, the size (i.e., dimensions) of a transformer may be minimized. Moreover, constructing a transformer core of multiple materials may minimize performance changes of a transformer, such as changes in inductance of a transformer across temperature variations.

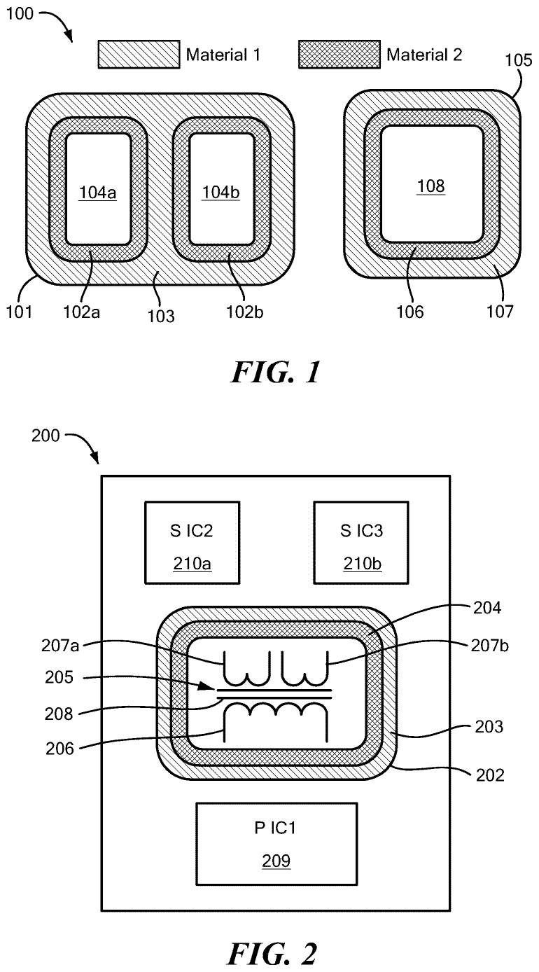

FIG. 1 is a diagram 100 of example multi-component transformer cores 101, 105 consistent with embodiments of the present disclosure. A transformer core may be constructed of multiple different components. The different components may be constructed of different materials. Example transformer core 105 is rectangular in shape and is constructed of at least two different components made of at least two different materials. For example, in FIG. 1, transformer core 105 is constructed of a first component 107 made of a first material and a second component 106 made of a second material. Transformer core 105 may have an aperture 108 in the middle of the transformer core. Transformer core 105 may be constructed such that a second component 106 surrounds an aperture in a plane, and such that a first component 107 surrounds second material 106 in the plane. That is, an inner surface of transformer core 105 surrounding an aperture 108 may be composed of second component 106 and an outer surface of transformer core 105 may be composed of first component 107. A conductive coil of a primary side of a circuit and a conductive coil of a secondary side of a circuit may then be wrapped around transformer core 105, such that the coils pass around transformer core 105 through the aperture of the transformer and around the outside of transformer core 105.

Although FIG. 1 shows transformer core 105 as being rectangular in shape, the disclosure is not so limited. A person of ordinary skill in the art would recognize, for example, that a similar multi-component structure may be used to construct a transformer core having any of a variety of different shapes, such as toroids (i.e., rings), cylinders, or any other shape having an aperture in it, such that conductive coils may be wrapped around the transformer core.

Example transformer core 101 is also rectangular in shape and constructed of at least two different components. The different components may be constructed out of different materials. For example, in FIG. 1, transformer core 101 is constructed of a first component 103, a second component 102a, and a third component 102b. First component 103 may be constructed of a first material, second component 102a may be constructed of a second material, and third component 102b may be constructed of a third material. The second material and third material may be the same material, or may be different materials. Transformer core 101 may have at least two apertures. For example, in FIG. 1, transformer core 101 has a first aperture 104a and a second aperture 104b. Transformer core 101 may be constructed such that second component 102a surrounds first aperture 104a in a plane, such that third component 102b surrounds second aperture 104b in the plane, and such that first component 103 surrounds second component 102a and third component 102b in the plane. As such, an inner surface of transformer core 101 surrounding first aperture 104a may be composed of second component 102a, an inner surface of transformer core 101 surrounding second aperture 104b may be composed of third component 102b, and an outer surface of transformer core 101 may be composed of first component 103. A first conductive coil for inputting a signal of a primary side circuit and a first conductive coil for outputting a corresponding signal in a secondary side circuit may be wrapped around transformer core 101 about aperture 104a (e.g., around the transformer core and passing through aperture 104a and around the outside of transformer core 101). Similarly, a second conductive coil for inputting a signal of a primary side circuit and a second conductive coil for outputting a corresponding signal in a secondary side circuit may be wrapped around transformer core 101 about aperture 104b (e.g., around the transformer core and passing through aperture 104b and around the outside of transformer core 101). In this way, transformer core 101 may be utilized to implement multiple channels of a circuit, with a first channel signal passing between the conductive coils wrapped about first aperture 104a, and a second channel signal passing between the conductive coils wrapped about second aperture 104b.

Although FIG. 1 shows transformer core 101 as being rectangular in shape, the disclosure is not so limited. A person of ordinary skill in the art would recognize, for example, that a similar multi-component structure may be used to construct a transformer core having any of a variety of different shapes, such as toroids (i.e., rings), cylinders, or any other shape having an aperture in it such that conductive coils may be wrapped around the transformer core.

Additionally, although FIG. 1 illustrates transformer core 101 as having two apertures, the disclosure is not so limited. A person of ordinary skill in the art would recognize, for example, that a similar multi-component structure may be used to construct a transformer core having any number of apertures. In some embodiments, each of the apertures in a transformer core may be surrounded by the same type of material. In some embodiments, one or more (or all) of the apertures in a transformer core may be surrounded by different types of materials.

Moreover, although FIG. 1 illustrates transformer core 101 and transformer core 105 as having two layers of materials between the aperture of the transformer core and the outside surface of the transformer core, the disclosure is not so limited. A transformer core may contain any number (e.g., 3) of layers of materials between an aperture of the transformer core and an outside surface of the transformer core. In some embodiments, each of the layers may be constructed of a different material. In other embodiments, some of the layers may be constructed of the same material, while other layers may be constructed of a different material.

FIG. 2 is a diagram of an example multi-channel system 200 including a substrate, multi-component transformer, and primary and secondary side circuits, consistent with embodiments of the present disclosure. In some embodiments, for example, system 200 may be used to provide a circuit with galvanic isolation and multiple channels. FIG. 2, for example, shows a system 200 that may be used to provide two channels, though the disclosure is not so limited. In some embodiments, system 200 may be utilized to provide galvanic isolation and multiple channels for a gate driver circuit, though the disclosure is not so limited.

As shown in FIG. 2, system 200 may include a substrate 201 supporting a magnetic transformer core 202 having transformer coils wrapped about an aperture 205 in magnetic transformer core 202. For example, FIG. 2 illustrates system 200 as including one primary side coil 206 wrapped about aperture 205 in magnetic transformer core 202, and two secondary side coils 207a, 207b wrapped about aperture 205 in magnetic transformer core 202. The two solid lines 208 symbolize that the coils 206, 207a, 207b are wrapped around a magnetic (e.g., ferrite) core (e.g., core 202). In some embodiments, magnetic transformer core 202 may be constructed as discussed with respect to FIG. 1. For example, magnetic transformer core 202 may be the same as transformer core 105, through the disclosure is not so limited.

In some embodiments, a primary side circuit (e.g., primary side integrated circuit (IC) 209, illustrated in FIG. 2 as “P IC1”) may be connected (e.g., electrically connected) to primary side coil 206, a first secondary side circuit (e.g., secondary side IC 210a, illustrated in FIG. 2 as “S IC2”) may be connected (e.g., electrically connected) to secondary side coil 207a, and a second secondary side circuit (e.g., secondary side IC 210b, illustrated in FIG. 2 as “S IC3”) may be connected (e.g., electrically connected) to secondary side coil 207b. In some embodiments, each of secondary side ICs 210a and 210b may include a gate driver circuit suitable for control of a semiconductor power switch (e.g., SiC FET, GaN FET, or the like).

In some embodiments, primary side circuit 209 may comprise control circuitry configured to supply control pulses to primary coil 206. For example, the control pulses may conveyed magnetically through magnetic transformer core 202 and output from secondary coils 207a and/or 207b to secondary side circuits 210a and/or 210b to drive one or more gates (not shown).

Although FIG. 2 illustrates system 200 as including one primary side circuit 209 and one primary side coil 206, and two secondary side circuits 210a, 210b and two secondary side coils 207a, 207b, the disclosure is not so limited. A person of ordinary skill in the art would recognize that a system may include any number of primary side coils (e.g., 1, 2, 3, 4, 5, or more primary side coils) and primary side circuits (e.g., 1, 2, 3, 4, 5, or more primary side circuits). Similarly, a person of ordinary skill in the art would recognize that a system may include any number of secondary side coils (e.g., 1, 2, 3, 4, 5, or more secondary coils) and secondary side circuits (e.g., 1, 2, 3, 4, 5, or more secondary side circuits). For example, a transformer core 202 may be sized so as to provide spacing for any number of primary and/or secondary side coils.

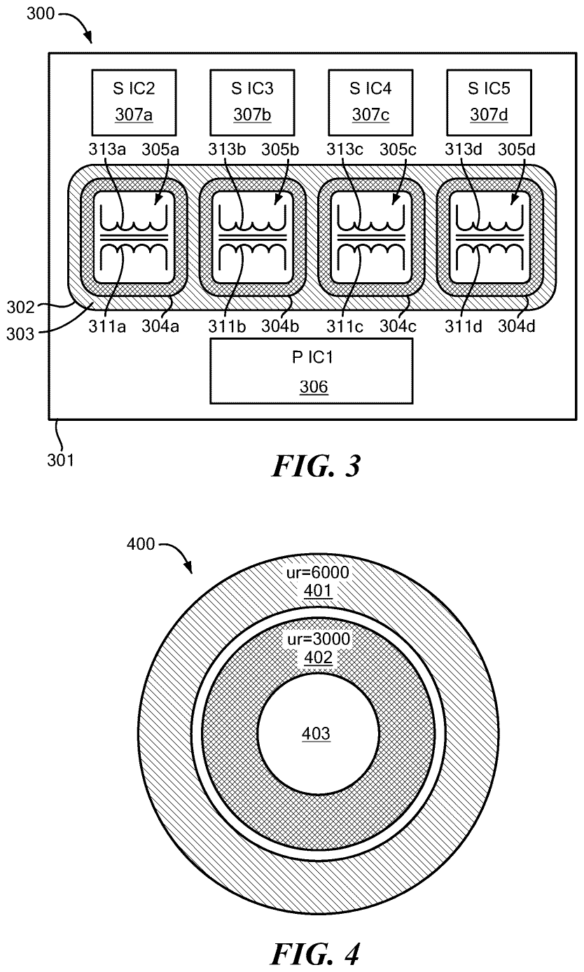

FIG. 3 is a diagram of another example multi-channel system 300 including a substrate, multi-component transformer, and primary and secondary side circuits, consistent with embodiments of the present disclosure. In some embodiments, for example, system 300 may be used to provide a circuit with galvanic isolation and multiple channels. FIG. 3, for example, shows a system 300 that may be used to provide four channels, though the disclosure is not so limited. In some embodiments, system 300 may be utilized to provide galvanic isolation and multiple channels for a gate driver circuit, though the disclosure is not so limited.

As shown in FIG. 3, system 300 may include a substrate 301 supporting a magnetic core 302 having transformer coils wrapped about apertures in a magnetic transformer core 302. For example, FIG. 3 illustrates system 300 as including four apertures, aperture 305a, aperture 305b, aperture 305c, and aperture 305d. Transformer core 302 may be constructed of five components, a first component 303, a second component 304a, a third component 304b, a fourth component 304c, and a fifth component 304d. In some embodiments, first component 303 may be constructed of a first material, second component 304a may be constructed of a second material, third component 304b may be constructed of a third material, fourth component 304c may be constructed of a fourth material, and fifth component 304d may be constructed of a fifth material. In some embodiments, the second material, third material, fourth material, and fifth material may be the same type of material, and the first material may be a different type of material than any of the second material, the third material, the fourth material, and the fifth material. In other embodiments, one or more of the second material, the third material, the fourth material, or the fifth material may be a different type of material than one or more others of the second material, the third material, the fourth material, or the fifth material. In some embodiments, magnetic transformer core 302 may be constructed as discussed with respect to FIG. 1. For example, magnetic transformer core 302 may be constructed as discussed above with respect to transformer core 105, except that transformer core 302 includes two more components (e.g., fourth component 304c, fifth component 304d) and two more apertures (e.g., aperture 305c, aperture 305d).

FIG. 3 illustrates system 300 as including one primary side coil 311a wrapped about aperture 305a and one secondary side coil 313a wrapped about aperture 305a. FIG. 3 also illustrates system 300 as including one primary side coil 311b wrapped about aperture 305b and one secondary side coil 313b wrapped about aperture 305b. FIG. 3 further illustrates system 300 as including one primary side coil 311c wrapped about aperture 305c and one secondary side coil 313c wrapped about aperture 305c. FIG. 3 still further illustrates system 300 as including one primary side coil 311d wrapped about aperture 305d and one secondary side coil 313d wrapped about aperture 305d.

In some embodiments, a primary side circuit (e.g., primary side IC 306, illustrated in FIG. 3 as “P IC1”) may be connected to primary side coil 311a, primary side coil 311b, primary side coil 311c, and primary side coil 311d, though the disclosure is not so limited. In some embodiments, one primary side circuit (e.g., IC) may be connected to one or more of primary side coil 311a, primary side coil 311b, primary side coil 311c, or primary side coil 311d, and another primary side circuit (e.g., IC) may be connected to one or more others of primary side coil 311a, primary side coil 311b, primary side coil 311c, or primary side coil 311d. In some embodiments, each of primary side coil 311a, primary side coil 311b, primary side coil 311c, and primary side coil 311d may be connected to a different primary side circuit (e.g., IC), such that there are four different primary side circuits.

In some embodiments, a first secondary side circuit 307a (e.g., secondary side IC 307a, illustrated in FIG. 3 as “S IC2”) may be connected to secondary side coil 313a. In some embodiments, a second secondary side circuit 307b (e.g., secondary side IC 307b, illustrated in FIG. 3 as “S IC3”) may be connected to secondary side coil 313b. In some embodiments, a third secondary side circuit 307c (e.g., secondary side IC 307c, illustrated in FIG. 3 as “S IC4”) may be connected to secondary side coil 313c. In some embodiments, a fourth secondary side circuit 307d (e.g., secondary side IC 307d, illustrated in FIG. 3 as “S IC5”) may be connected to secondary side coil 313d. However, the disclosure is not so limited. In some embodiments, all of secondary side coils 313a, 313b, 313c, and 313d may be connected to a single secondary side circuit (IC). In other embodiments, some of secondary side coils 313a, 313b, 313c, or 313d may be connected to a first secondary side circuit (IC) and others of secondary side coils 313a, 313b, 313c, or 313d may be connected to a second secondary side circuit (IC).

In some embodiments, each of the secondary side circuits (e.g., S IC2 307a, S IC3 307b, S IC 4 307c, S IC5 307d) may include a gate driver circuit suitable for control of a semiconductor power switch (e.g., SiC FET, GaN FET, or the like).

In some embodiments, primary side circuit 306 may comprise control circuitry configured to supply control pulses to primary coil 311a, 311b, 311c, and/or 311d. For example, the control pulses may conveyed magnetically through magnetic transformer core 302 and output from secondary coils 313a, 313b, 313c, and/or 313d to secondary side circuits 307a, 307b, 307c, and/or 307d to drive one or more gates (not shown).

Although FIG. 3 illustrates system 300 as including one primary side circuit 306 and four primary side coils 311a, 311b, 311c, 311d, the disclosure is not so limited. A person of ordinary skill in the art would recognize that a system may include any number of primary side coils (e.g., 1, 2, 3, 4, 5, or more primary side coils) and primary side circuits (e.g., 1, 2, 3, 4, 5, or more primary side circuits). Additionally, although FIG. 3 illustrates system 300 as including four secondary side circuits 307a, 307b, 307c, 307d and four secondary side coils 313a, 313b, 313c, 313d, the disclosure is not so limited. A person of ordinary skill in the art would recognize that a system may include any number of secondary side coils (e.g., 1, 2, 3, 4, 5, or more secondary side coils) and secondary side circuits (e.g., 1, 2, 3, 4, 5, or more secondary side circuits). For example, a transformer core 302 may be sized so as to provide spacing for any number of apertures (e.g., 1, 2, 3, 4, 5, or more) to accommodate any number of primary and/or secondary side coils.

Any suitable material may be used for a substrate of a system (e.g., system 200, system 300), such as for substrate 201 or substrate 301. Example materials include, but are not limited to, printed circuit boards (PCBs), lead frames, ceramic substrates (e.g., including low-temperature co-fired ceramic, high-temperature co-fired ceramic, etc.), glass substrates, and the like. In some embodiments, a system may omit a substrate and may, for example, use a wire-wound transformer core mounted to another type of structure.

Any suitable soft ferromagnetic material may be used for a material used in a component of a transformer core. For example, any suitable soft ferromagnetic material may be used for the material in component 106, component 107, component 103, component 102a, or component 102b of FIG. 1, for component 203 or component 204 of system 200 of FIG. 2, or for component 303, component 304a, component 304b, component 304c, or component 304d of system 300 of FIG. 3. Example materials include, but are not limited to, ferrite (solid or sintered), ferrosilicon, nickel, nickel alloys (e.g., iron nickel, nickel zinc), zinc, zinc alloys, manganese, manganese alloys (e.g., manganese zinc), and/or the like. In some embodiments magnetic cores of transformers may have shapes including closed loops of various geometries, e.g., rectangular loops, ellipsoidal loops, square loops, circular loops, etc. In some embodiments, an insulative adhesive may be used between a magnetic core and the substrate on which the magnetic core is mounted, and/or between a magnetic core and coil windings. A person of ordinary skill in the art would recognize that a soft ferromagnetic material may generally be a material (e.g., ferrite) that has low coercivity (i.e., easy to demagnetize and does not make a good permanent magnet) as compared to hard ferromagnetic materials (e.g., ferrites) that have high coercivity (i.e., does not demagnetize easily). The term “coercivity” may generally refer to the intensity of a magnetic field required to de-magnetize a material after it has been magnetized as much as possible.

Different ferromagnetic materials may have different permeabilities. The term “permeability” may generally refer to the ability of a material to store or focus magnetic energy, or the degree to which a material becomes magnetized by an applied magnetic field. A material's permeability may be determined by the way the material's electrons respond to an applied magnetic field. If there are electrons available to line up their spins to reinforce the magnetic field, the material may have a high permeability and may concentrate the magnetic field. Such materials may include, for example, iron, zinc, and cobalt. Other materials do not have electrons available to line up their spins to reinforce the magnetic field and so have a low permeability and do not concentrate the magnetic field. Example materials with low permeability include carbon and oxygen, for example. A value for permeability of a material may be given as a relative value, with air having a value of 1, and ferrites having relative permeabilities ranging anywhere from 10 to 10,000. Magnetic permeability may be represented in units of μ, where μ can be represented by the following equation

$$μ = \frac{B}{H} , \qquad Equation 1$$

where B is the magnetic flux density established within the material, and H is the magnetic field strength of the magnetizing field (i.e., the field produced by the flow of electric current through the coiled wire).

Permeability of a material may vary depending on a frequency of a current flowing in a winding that generates the magnetic field applied to the material. Permeability of a material may also vary depending on the ambient temperature around the material. For example, the permeability of a ferrite may increase as temperature rises until reaching a local maximum at a certain temperature, at which point permeability of the ferrite may disappear as the temperature rises further.

Different ferromagnetic materials may also have different saturation levels. The term “saturation” may generally refer to the point at which increases in inductor current do not cause a proportional increase of magnetic flux in the material. Saturation of a material may also vary depending on the ambient temperature around the material. For example, saturation magnetization of a ferrite material may significantly decrease as temperature increases, such that the maximum magnetic flux density a ferrite core may hold may reduce with rising temperatures.

Ferrite magnetic cores for use in transformers may be made by mixing materials (e.g., metal oxide powders) and various binding agents and placing the materials and binding agents into a mold, where they may be heated and squeezed until a ceramic is created in a process referred to as sintering. As discussed above, different materials may have different characteristics (e.g., permeability, saturation, coercivity). As a result, mixes of different materials may be selected to construct a ferrite magnetic core with properties tailored for use in particular conditions, such as for use within a particular frequency range of current passing through a winding and/or within a particular temperature range. A mix of materials used in constructing a ferrite magnetic core may together constitute a “first material,” “second material,” or “third material” as described with respect to FIG. 1, a “first material” or “second material” as described with respect to FIG. 2, or a “first material,” “second material,” “third material,” “fourth material,” or fifth material” as described with respect to FIG. 3. That is, component 106, component 107, component 103, component 102a, component 102b, component 203, component 204, component 303, component 304a, component 304b, component 304c, component 304d, component 401, component 402, component 501, and/or component 502 may comprise a mix of different materials, such as metal oxide powders. Alternatively, in some embodiments, component 106, component 107, component 103, component 102a, component 102b, component 203, component 204, component 303, component 304a, component 304b, component 304c, component 304d, component 401, component 402, component 501, and/or component 502 may comprise a single material.

In some embodiments, a three-dimensional (3D) printer may be used to form one or more components of a multi-component transformer core. For example, one or more materials (e.g., metal oxides) may be mixed together and printed, or injected into a mold, to create a component having a particular desired shape and/or dimensions.

As previously discussed, use of a transformer in a circuit may impose constraints on the circuit. For example, a transformer may be a large component, and may require a lot of space on a substrate (e.g., printed circuit board, integrated circuit (IC)) on which a circuit is implemented. The size of these components may make it challenging to use transformers in smaller packages, such as in small, pre-packaged ICs. As discussed above, transformers may also have characteristics that vary depending on the environment in which they are implemented. For example, permeability of a transformer may vary as frequency of the current generating the magnetic field varies or as temperature in an environment varies. Similarly, saturation of a transformer may vary as temperature in an environment varies. Inductance is directly related to permeability and saturation, and therefore inductance of the transformer may also vary as frequency and/or temperature varies. These variations in the properties of a transformer may be problematic in circuits that are used in certain environments, such as in outdoor applications such as electric vehicle (EV) chargers or industrial applications in harsh environments where temperatures may vary widely. While a transformer core may be made of a particular mix of materials designed for certain applications, such a transformer core may still not perform as well as desired for certain applications.

As previously discussed, systems, methods, and structures provided herein may address these potential problems. That is, systems, methods, and structures disclosed herein provide for transformer cores constructed of multiple components, such that each of the components may be made of different materials and may have different characteristics. By selecting components constructed of materials having desired characteristics for a particular application, a multi-component transformer core may be constructed that is smaller in size and/or that operates with more consistency over desired frequency ranges and/or temperature ranges.

FIG. 4 is a diagram of an example multi-component transformer core 400, consistent with embodiments of the present disclosure. A multi-component transformer core may be constructed of two or more components. In some embodiments, the two or more components may be constructed of different materials.

For example, FIG. 4 illustrates example multi-component transformer core 400 as being constructed of two components, a first component 401 and a second component 402. First component 401 may be constructed of a first material (e.g., a single first material or a first mix of materials, such as metal oxide powders) and second component 402 may be constructed of a second material (e.g., a single second material or a second mix of materials, such as mix of metal oxide powders). As shown in FIG. 4, second component 402 may surround an aperture 403 in a plane, and first component 401 may surround second component 402 in the plane.

The first material of first component 401 and the second material of second component 402 may have different characteristics. In the example shown in FIG. 4, the first material of first component 401 has a relative magnetic permeability (uᵣ) of 6,000 (e.g., at room temperature), and the second material of second component 402 has a relative permeability (uᵣ) of 3,000 (e.g., at room temperature). The relative magnetic permeability (uᵣ) of a component may depend on the mix of one or more materials used to construct the component and/or the inner and outer diameters of the component.

Surrounding one core (e.g., second component 402) constructed of a second material having a second permeability with another core (e.g., first component 401) constructed of a first material having a first permeability higher than the second permeability may increase utilization of the overall core (e.g., multi-component core 400). That is, in a single core implementation, such as an implementation where only component 402 is utilized as the transformer core, the magnetic field strength on an outer diameter of the of the core may be almost half of the magnetic field strength on an inner diameter of the core. Utilizing a multi-component core where an outer core (e.g., first component 401) having a first permeability surrounds an inner core (e.g., second component 402) having a second permeability, and where the first permeability is greater than the second permeability (e.g., as shown in FIG. 4), may allow the overall core (e.g., multi-component core 400) to increase inductance as compared to a single core implementation, and may therefore allow for reduction in thickness of the overall core (e.g., multi-component core 400) as compared to a single core implementation. Such a reduction in size may allow circuits (e.g., ICs) including the transformer core to be constructed that are smaller in size than circuits including single component transformer cores, which may have advantages in applications with size constraints.

Additionally, the outer core (e.g., first component 401) may be selected to be constructed of a material that has a high permeability over a wide temperature range. Utilizing a multi-component core where an outer core (e.g., first component 401) having a high permeability over a wide temperature range surrounds an inner core (e.g., second component 402) having a second permeability lower than the first permeability, may allow the overall core (e.g., multi-component core 400) to have a reduced (e.g., flatter) variation in inductance over a given temperature range (e.g., such as a flatter variation when operating a system in cold temperatures) as compared to a single core implementation (or as compared to a multi-core implementation where first component 401 and second component 402 are constructed of the same soft ferromagnetic material). Such a multi-component core 400 may be useful in systems used in harsh environments, such as electric vehicle chargers (which can experience a wide range in temperatures) or in industrial applications where harsh environments may be present. In some embodiments, the inner and outer cores may be constructed of components having differing permeabilities such that the inductance of the multi-component core is relatively flat over a temperature range of about −60° Celsius to about +200° Celsius. For example, a MnZn component (e.g., an R5KT component from Hengdian Group DMEGC Magnetics Co., Ltd.) having certain characteristics (e.g., a high permeability over a wide temperature range) may be used as the outer core. In some embodiments, a MnZn component having certain characteristics (e.g., a high permeability over a wide temperature range) may be used as the outer core, inner core, and/or both the outer core and inner core.

In some embodiments, first component 401 may be located in a first region and second component 402 may be located in a second region, as shown in FIG. 4 (and as also shown in FIGS. 1-3, 5A, 5B). In some embodiments, a first component (e.g., first component 401) and a second component (e.g., second component 402) may be selected and located so as to provide a transformer that has a controlled gradient of magnetic permeability from the first region to the second region. In some embodiments, the controlled gradient of magnetic permeability may increase in a direction away from a center (i.e., center of the aperture of a multi-component transformer core). In some embodiments, the controlled gradient of magnetic permeability may be linear. In other embodiments, the controlled gradient of magnetic permeability may be exponential.

In some embodiments, a third component (not shown) may be located in a third region and may surround a first component and a second component of a multi-component magnetic core. For example, a third component in the form of a third concentric ring may surround first component 401 of FIG. 4. In some embodiments, the third component may be constructed of a third material. In some embodiments, the third material may have a third magnetic permeability different than the magnetic permeabilities of the materials of a first component and of a second component. For example, the third material of the third component may have a higher permeability than the materials of the first and second components. Using a third component in this manner may result in an improved overall gradient of permeability for a multi-component transformer core as compared to a multi-component transformer core with two components.

In some embodiments, a first component (e.g., component 107, component 103, component 203, component 303, component 401, component 501) and a second component (e.g., component 106, component 102a, component 102b, component 204, component 304a, 304b, 304c, 304d, component 402, component 502) may each be constructed of materials that comprise ferrite. In some embodiments, a first component (e.g., component 107, component 103, component 203, component 303, component 401, component 501) and a second component (e.g., component 106, component 102a, component 102b, component 204, component 304a, component 304b, component 304c, component 304d, component 402, component 502) may each be constructed of different materials that comprise ferrite.

In some embodiments, a first component (e.g., component 107, component 103, component 203, component 303, component 401, component 501) may comprise any of a DMR95, DMR95H, or R5KT component from Hengdian Group DMEGC Magnetics Co., a P452 component from ACME Electronics Corporation, or a NP2 component from Encore Electronics Technology Co., Ltd. In some embodiments, a second component (e.g., component 106, component 102a, component 102b, component 204, component 304a, component 304b, component 304c, component 304d, component 402, component 502) may comprise any of a DMR95, DMR95H, or R5KT component from Hengdian Group DMEGC Magnetics Co., a P452 component from ACME Electronics Corporation, or a NP2 component from Encore Electronics Technology Co., Ltd. In some embodiments, a third component may comprise any of a DMR95, DMR95H, or R5KT component from Hengdian Group DMEGC Magnetics Co., a P452 component from ACME Electronics Corporation, or a NP2 component from Encore Electronics Technology Co., Ltd. In some embodiments, a first component comprising an outer core may comprise a R5KT component from Hengdian Group DMEGC Magnetics Co., and a second component comprising an outer core may comprise a DMR95 component from Hengdian Group DMEGC Magnetics Co.

In some embodiments, a first component (e.g., component 107, component 103, component 203, component 303, component 401, component 501) and a second component (e.g., component 106, component 102a, component 102b, component 204, component 304a, component 304b, component 304c, component 304d, component 402, component 502) may be joined (e.g., bonded, pressed, press fit, compressed together, heated or cooled together, welded together) to form a multi-component transformer core (e.g., core 105, core 101, core 202, core 302, core 400, core of view 500, core of view 550).

In some embodiments, a first component (e.g., component 107, component 103, component 203, component 303, component 401, component 501) and a second component (e.g., component 106, component 102a, component 102b, component 204, component 304a, component 304b, component 304c, component 304d, component 402, component 502) may be bonded together, such as with an epoxy, glue, gel, or other type of adhesive, to form a multi-component core (e.g., core 105, core 101, core 202, core 302, core 400, core of view 500, core of view 550). In some embodiments, a first component (e.g., component 107, component 103, component 203, component 303, component 401, component 501) and a second component (e.g., component 106, component 102a, component 102b, component 204, component 304a, component 304b, component 304c, component t304d, component 402, component 502) may be placed adjacent to each other in a molded cavity to form a multi-component core (e.g., core 105, core 101, core 202, core 302, core 400, core of view 500, core of view 550).

In some embodiments, a first component (e.g., component 107, component 103, component 203, component 303, component 401, component 501) and a second component (e.g., component 106, component 102a, component 102b, component 204, component 304a, component 304b, component 304c, component 304d, component 402, component 502) may be pressed together to form a multi-component core (e.g., core 105, core 101, core 202, core 302, core 400, core of view 500, core of view 550). In some embodiments, a first component (e.g., component 107, component 103, component 203, component 303, component 401, component 501) and a second component (e.g., component 106, component 102a, component 102b, component 204, component 304a, component 304b, component 304c, component 304d, component 402, component 502) may be press fit together to form a multi-component core (e.g., core 105, core 101, core 202, core 302, core 400, core of view 500, core of view 550). In some embodiments, a first component (e.g., component 107, component 103, component 203, component 303, component 401, component 501) and a second component (e.g., component 106, component 102a, component 102b, component 204, component 304a, component 304b, component 304c, component 304d, component 402, component 502) may be compression fit together.

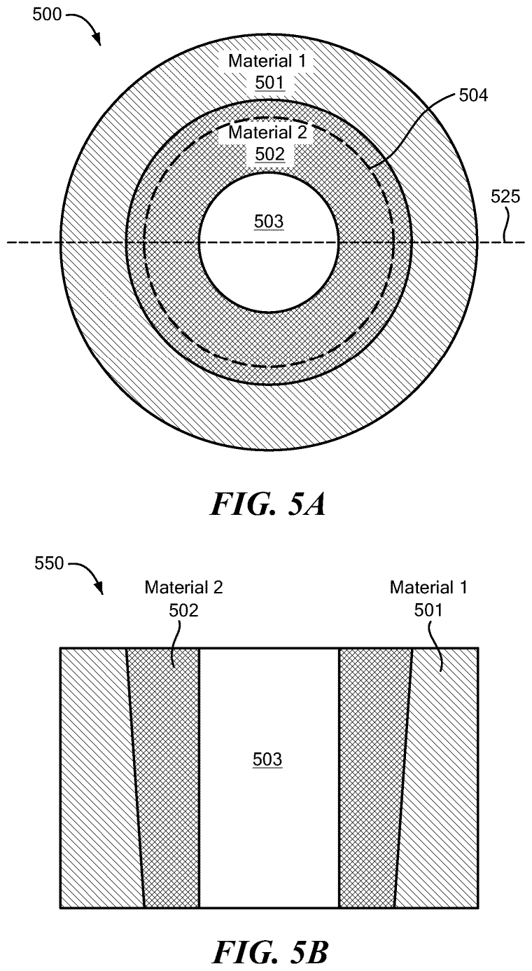

In some embodiments, a first surface of a first component (e.g., component 107, component 103, component 203, component 303, component 401, component 501) may be tapered (e.g., angled) and a first surface of a second component (e.g., component 106, component 102a, component 102b, component 204, component 304a, component 304b, component 304c, component 304d, component 402, component 502) may be tapered, such that the second component may be pressed into the first component (see, e.g., FIGS. 5A, 5B).

In some embodiments, a first component (e.g., component 107, component 103, component 203, component 303, component 401, component 501) and a second component (e.g., component 106, component 102a, component 102b, component 204, component 304a, component 304b, component 304c, component 304d, component 402, component 502) may be fit together to form a multi-component core (e.g., core 105, core 101, core 202, core 302, core 400, core of view 500, core of view 550) using thermal profiling and heating. For example, different materials of the first component and the second component may have different coefficients of thermal expansion (CTE). In some embodiments, an outer core (e.g., component 107, component 103, component 203, component 303, component 401, component 501) of a multi-component transformer core may be heated to fit an inner core (e.g., component 106, component 102a, component 102b, component 204, component 304a, component 304b, component 304c, component 304d, component 402, component 502) of the multi-component transformer core. In some embodiments, an inner core (e.g., component 106, component 102a, component 102b, component 204, component 304a, component 304b, component 304c, component 304d, component 402, component 502) may be cooled to fit an outer core (e.g., component 107, component 103, component 203, component 303, component 401, component 501) of a multi-component transformer core.

In some embodiments, a first component (e.g., component 107, component 103, component 203, component 303, component 401, component 501) and a second component (e.g., component 106, component 102a, component 102b, component 204, component 304a, component 304b, component 304c, component 304d, component 402, component 502) may be welded together, such as with laser welding.

A person of ordinary skill in the art would recognize there are a variety of different known techniques for attaching or placing two components in proximity to each other. It should be recognized that any of these techniques may be used to construct a multi-component transformer core, and these techniques should be considered to be within the scope of the disclosure herein.

Additionally, although techniques for constructing a multi-component transformer core constructed of two components were provided above, the disclosure is not so limited. The described techniques may be used to construct a multi-component transformer core constructed of any number (e.g., 2, 3, 4, 5, or more) of components, and the disclosure herein should be considered to include such embodiments. As just one example, a third component may be included that surrounds first component 401 of multi-component transformer core 400. As another example, a third (or more) components may be included so as to provide multiple apertures in a multi-component transformer core, such as shown in the examples of transformer core 101 of FIG. 1 and transformer core 301 of FIG. 3.

FIG. 5A is a diagram of a first view 500 of an example configuration of a multi-component transformer core, consistent with embodiments of the present disclosure. In some embodiments, the multi-component transformer core may be the same as multi-component transformer core 400 of FIG. 4, though the disclosure is not so limited. In some embodiments, the multi-component transformer core may be constructed in any of the manners discussed above with respect to multi-component transformer core 400 of FIG. 4, though the disclosure is not so limited.

FIG. 5A shows a view 500 from a top of an example multi-component transformer core. The example multi-component transformer core comprises a first component 501 constructed of a first material (e.g., a first single material or a first mix of materials, such as a mix of metal oxide powders) and a second component constructed of a second material (e.g., a second single material or a second mix of materials, such as a mix of metal oxide powders). Second component 502 may surround an aperture 503 in a plane, and first component 501 may surround second component 502 in the plane. In some embodiments, the surface of component 501 adjacent component 502 may be tapered, and the surface of component 502 adjacent component 501 may be tapered such that the surfaces of the two components meet closer to the center of aperture 503 on a bottom of the multi-component transformer core than on a top (shown in FIG. 5A) of the multi-component transformer core.

FIG. 5B is a diagram of a second view 550 of the example configuration of a multi-component transformer core shown in FIG. 5A, consistent with embodiments of the present disclosure. FIG. 5B shows a side view 550 of a cross-section along line 525 of the multi-component transformer core. As shown in in FIG. 5B, a first surface of first component 501 may be tapered (e.g., angled) and a first surface of second component 502 may be tapered (e.g., angled), such that second component 502 fits into first component 501. For example, as shown in FIG. 5B, a width of a first component 501 may be wider on a bottom of a multi-component transformer core than on a top of the multi-component transformer core. As shown in FIG. 5B, a width of second component 502 may be wider on a top of the multi-component transformer core than on a bottom of the multi-component transformer core. As shown in FIG. 5B, the angle at which the first surface of first component 501 is tapered may be the same (or substantially the same) as the angle at which the first surface of second component 502 is tapered, such that second component 502 may be pressed into first component 501.

In some embodiments, in addition to pressing second component 502 into first component 501, second component 502 and first component 501 may be further held in proximity by, for example, using an epoxy, gel, glue, or other adhesive to hold them together, placing them in a mold that holds them together, laser welding them together, compressing them together, or heating or cooling them to expand them together.

Although FIGS. 4, 5A, and 5B provide examples where a multi-component transformer core is formed out of a concentric ring-shaped (e.g., toroid) components, the disclosure is not so limited. For example, as previously discussed, a multi-component transformer core may be constructed to have any of a variety of different shapes, such as cylinders, rectangles, or any other shape having an aperture in it, such that conductive coils may be wrapped around the transformer core.

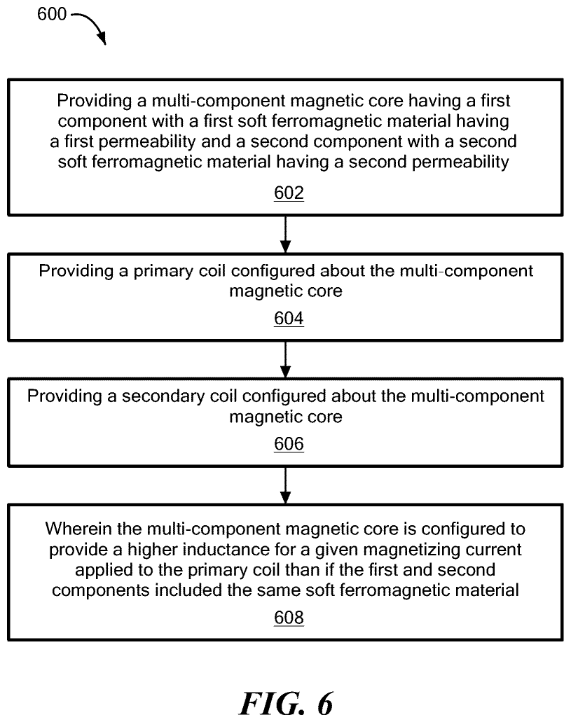

FIG. 6 is a flow chart of an example process 600 for making a magnetic isolation transformer with a multi-component magnetic core, consistent with embodiments of the present disclosure. The magnetic isolation transformer may be a transformer as discussed above with respect to systems 200 or 300, for example, and may include a transformer core as discussed above with respect to any of FIGS. 1-5B, for example.

In 602, a multi-component magnetic core having a first component with a first soft ferromagnetic material having a first permeability and a second component with a second soft ferromagnetic material having a second permeability may be provided. For example, as previously discussed, a first component (e.g., component 107, component 103, component 203, component 303, component 401, component 501) may be constructed of a first soft ferromagnetic material (e.g., a first single material or a first mix of materials, such as a mix of metal oxides) having a first permeability, and a second component (e.g., component 106, component 102a, component 102b, component 204, component 304a, component 304b, component 304c, component 304d, component 402, component 502) may be constructed of a second soft ferromagnetic material (e.g., a second single material or a second mix of materials, such as a mix of metal oxides). As previously discussed, the first component and/or second component may be constructed, for example, using a three-dimensional (3D) printer. As previously discussed, the first component and/or second component may be formed to have a particular shape and/or dimensions.

As also previously discussed, the multi-component magnetic transformer core may be formed by placing the first component and second component in proximity to each other, such as by placing them in a mold, joining them together, adhering them together (e.g., with an epoxy, glue, gel), compressing them together, inserting one of the components into the other component, joining them by heating or cooling them together, or using some other known technique for forming a component out of multiple separate components. As previously discussed, the multi-component magnetic transformer core may be constructed in any of a variety of shapes, such as a ring (e.g., toroidal) shape, rectangular shape, cylindrical shape, or any other shape with an aperture in the center for allowing conductive coils to be wrapped around the transformer core. Moreover, as previously discussed the multi-component transformer core may be constructed of any number of components, and with any number of apertures.

In 604, a primary coil may be configured about the multi-component magnetic transformer core. For example, a primary conductive coil may be wrapped about one side of a multi-component transformer core, such as was discussed above with respect to FIGS. 2 and 3. As previously discussed with respect to FIGS. 2 and 3, any number of primary conductive coils may be wrapped around one or more sides of a multi-component transformer core. For example, as previously discussed, a separate primary conductive coil may be wrapped around a side of the multi-component transformer core in each of any number of apertures in a multi-component magnetic core.

In 606, a secondary coil may be configured about the multi-component magnetic transformer core. For example, a secondary conductive coil may be wrapped about another side of a multi-component transformer core, such as was discussed above with respect to FIGS. 2 and 3. As previously discussed with respect to FIGS. 2 and 3, any number of secondary conductive coils may be wrapped around one or more sides of a multi-component transformer core. For example, as previously discussed, a separate secondary conductive coil may be wrapped around a side of a multi-component transformer core in each of any number of apertures in a multi-component magnetic core.

As noted in 608, the multi-component magnetic transformer core may be configured to provide a higher inductance for a given magnetizing current applied to the primary coil than if the first and second components included the same soft ferromagnetic material. That is, as previously discussed, selection of different components composed of different materials for an outer core and an inner core of a multi-component magnetic transformer core may result in a multi-component magnetic transformer core that provides a higher inductance for a given magnetizing current applied to the primary coil than for a single component magnetic transformer core (or for a multi-component transformer core having multiple components composed of the same material). As one example, by utilizing a multi-component where an outer core (e.g., component 107, component 103, component 203, component 303, component 401, component 501) having a first permeability surrounds an inner core (e.g., component 106, component 102a, component 102b, component 204, component 304a, component 304b, component 304c, component 304d, component 402, component 502) having a second permeability, and where the first permeability is greater than the second permeability (see, e.g., FIG. 4), may allow the overall multi-component transformer core to increase inductance for a given magnetizing current passing through a primary coil as compared to a single core implementation, and may therefore allow for reduction in thickness of the overall core (e.g., multi-component core) as compared to a single core implementation.

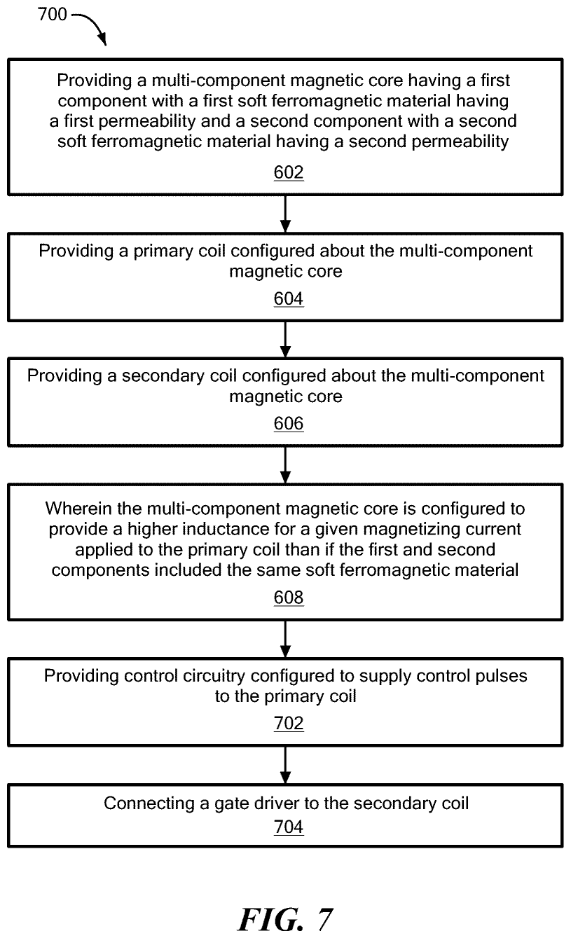

FIG. 7 is a flow chart of an example process 700 for making a system comprising a magnetic isolation transformer with a multi-component magnetic core, consistent with embodiments of the present disclosure. Process 700 may be used, for example, to make a system that includes a multi-component transformer, primary side circuitry, and secondary side circuitry, such as system 200 of FIG. 2 or system 300 of FIG. 3.

602-608 may be performed in the same manner as discussed above with respect to FIG. 6.

In 702, primary side circuitry may be provided. For example, control circuitry for sending current pulses to a primary side coil may be provided, though the disclosure is not so limited. Any type of primary side circuit may instead be provided. The primary side circuitry may be electrically connected to one or more primary side coils of the multi-component transformer.

In 704, secondary side circuitry may be provided. For example, gate driver circuitry for driving one or more components (e.g., power transistor(s)) may be provided, though the disclosure is not so limited. Any type of secondary side circuit may instead be provided. The secondary side circuitry may be electrically connected to one or more secondary side coils of the multi-component transformer.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

Various embodiments of the systems and methods are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure A over element or structure B include situations in which one or more intermediate elements or structures (e.g., element C) is between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same. Also, as used herein, “and/or” means “and” or “or,” as well as “and” and “or.” Moreover, all patent and non-patent literature cited herein is hereby incorporated by references in their entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

It should be recognized that values described herein may be exact or approximate. One of ordinary skill in the art would recognize that values described herein may vary depending on, for example, manufacturing tolerances of components in sensor devices. As a result, values that deviate from a described value by up to +/−20% of the described value may be deemed to correspond to the value described.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described with reference to one embodiment, knowledge of one skilled in the art may be relied upon to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A system comprising a magnetic isolation transformer, the magnetic isolation transformer comprising:
a multi-component magnetic core having a first component with a first soft ferromagnetic material having a first permeability and a second component with a second soft ferromagnetic material having a second permeability;
a primary coil configured about the multi-component magnetic core; and
a secondary coil configured about the multi-component magnetic core,
wherein the multi-component magnetic core is configured to provide reduced variation in inductance across a given temperature range than if the first and second components included the same soft ferromagnetic material.

2. The system of claim 1, further comprising control circuitry configured to supply control pulses to the primary coil.

3. The system of claim 1, further comprising a gate driver integrated circuit (IC) connected to the secondary coil.

4. The system of claim 1, wherein the first component is in a first region and the second component is in a second region, and wherein the magnetic isolation transformer includes a controlled gradient of magnetic permeability from the first region to the second region, the controlled gradient increasing away from a center of the multi-component magnetic core.

5. The system of claim 4, wherein the controlled gradient of magnetic permeability is linear.

6. The system of claim 4, wherein the controlled gradient of magnetic permeability is exponential.

7. The system of claim 1, further comprising a third core component having a third soft ferromagnetic material with a third magnetic permeability.

8. The system of claim 1, wherein the first component and/or the second component comprises ferrite.

9. The system of claim 1, wherein the second permeability is greater than the first permeability.

10. A method of making a system comprising a magnetic isolation transformer with a multi-component magnetic core, the method comprising:
providing a multi-component magnetic core having a first component with a first soft ferromagnetic material having a first permeability and a second component with a second soft ferromagnetic material having a second permeability;
providing a primary coil configured about the multi-component magnetic core; and
providing a secondary coil configured about the multi-component magnetic core,
wherein the multi-component magnetic core is configured to provide reduced variation in inductance across a given temperature range than if the first and second components included the same soft ferromagnetic material.

11. The method of claim 10, further comprising providing control circuitry configured to supply control pulses to the primary coil.

12. The method of claim 10, further comprising connecting a gate driver integrated circuit (IC) to the secondary coil.

13. The method of claim 10, wherein the first component is in a first region and the second component is in a second region, and wherein the magnetic isolation transformer includes a controlled gradient of magnetic permeability from the first region to the second region, the controlled gradient increasing away from a center of the multi-component magnetic core.

14. The method of claim 13, wherein the controlled gradient of magnetic permeability is linear.

15. The method of claim 13, wherein the controlled gradient of magnetic permeability is exponential.

16. The method of claim 10, further comprising using a three-dimensional (3D) printer to form at least one component of the multi-component magnetic core.

17. The method of claim 10, further comprising joining the first and second components.

18. The method of claim 17, wherein joining the first and second components includes bonding.

19. The method of claim 17, wherein joining the first and second components includes press fitting.

20. The method of claim 17, wherein joining the first and second components includes heating or cooling one or more of the first or second components.

21. The method of claim 10, wherein the first component and/or the second component comprises ferrite.

22. The method of claim 10, wherein the second permeability is greater than the first permeability.

23. A magnetic isolation transformer comprising:
a multi-component magnetic core having a first component with a first soft ferromagnetic material having a first permeability and a second component with a second soft ferromagnetic material having a second permeability;
a primary coil configured about the multi-component magnetic core; and
a secondary coil configured about the multi-component magnetic core,
wherein the multi-component magnetic core is configured to provide reduced variation in inductance across a given temperature range than if the first and second components included the same soft ferromagnetic material.
